(19) United States
(12) Patent Application Publication
(10) Pub. No.: US 2012/0154128 A1
(43) Pub. Date: Jun. 21, 2012

(54) APPARATUS AND METHOD FOR WIRELESSLY CONTROLLING A SYSTEM OR APPLIANCE

(76) Inventors: Sunguk Cho, Seoul (KR); Hoocheol Lee, Seoul (KR); Muhyun Moon, Seoul (KR); Dongbum Hwang, Seoul (KR); Sooyoung Lee, Seoul (KR)

(21) Appl. No.: 13/312,394

(22) Filed: Dec. 6, 2011

(30) Foreign Application Priority Data
Dec. 16, 2010 (KR) 10-2010-0129109

(51) Int. Cl. G05B 11/01

(52) U.S. Cl. 340/12.5

(57) ABSTRACT

A terminal includes a first interface to receive an application for controlling an appliance, a memory to store the application received through the first interface, and a controller to control formation of a wireless link between the terminal and appliance, synchronization of an attribute of the appliance through the wireless link, and display of info nation identifying a function or set value corresponding to the attribute. The controller may also control execution of the application to transmit a first signal, which may be one for causing an operation to be performed for the appliance.

### CROSS-REFERENCE TO RELATED APPLICATIONS

This application claims priority to Korean Patent Application No. 10-2010-0129109 filed on Dec. 16, 2010, the contents of which are incorporated by reference.

### BACKGROUND

1. Field

Embodiments herein relate to wireless control of a system or appliance.

2. Background

Improved control of air conditioners, washers, dryers, security systems, entertainment devices, and other appliances and systems continues to be of interest to manufacturers. These appliances and systems may be used in the home for personal use or may be ones found in commercial, industrial, or corporate setting.

### BRIEF DESCRIPTION OF THE DRAWINGS

FIG. 1 shows a communication between a terminal and appliance or system.

FIGS. 2 to 4 show operations for downloading an application to the terminal.

FIG. 5 shows a method for establishing communication between the terminal and an appliance or system.

FIGS. 6 to 8 show information that may be displayed on the terminal when a terminal which is to be in communication with an appliance or system.

FIG. 9 shows information that may be displayed on a terminal when the terminal is not in communication with the appliance or system.

FIG. 10 shows another way in which a terminal may communicate with a system or appliance.

FIG. 11 shows another method for establishing communication between a terminal and the system or appliance.

FIG. 12 shows a synchronization operation performed between a terminal and a system or appliance.

FIG. 13 shows a method for performing synchronization between a terminal and a system or appliance.

FIG. 14 shows an embodiment in which a plurality of terminals attempt to establish communication with an appliance or system.

FIGS. 15 to 18 show an operation where a terminal displays various types of information including ones identifying functions of a system or appliance to be controlled.

### DETAILED DESCRIPTION

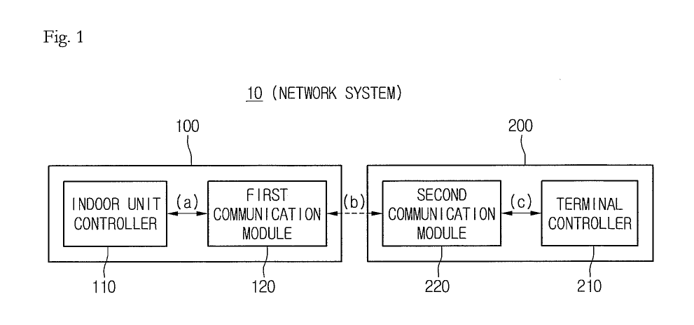

FIG. 1 shows an embodiment of a network system 10 that includes an appliance or system 100 and a terminal 200. The appliance or system 100 is to be controlled based on one or more embodiments described herein, and may be one found in the home, work, industrial, commercial or corporate setting. In accordance with one embodiment, the appliance may be an air conditioner, and the terminal 200 may be set in communication with the air conditioner in order to exchange information and/or commands for controlling operation of the air conditioner

The terminal 200 may be, for example, a portable user terminal which may transmit/receive specific information with other terminals and/or appliance or system 100. As an example, a user may perform voice call or video call with another user terminal using the terminal 200, and the terminal 200 may transmit/receive specific data to/from another terminal. In other embodiments, the terminal may be another type of device such as a laptop or notebook computer, a pod-type device, or a tablet, just to name a few.

The air conditioner 100 includes an indoor unit controller 110 for controlling an indoor unit disposed in an indoor space, and a first communication module 120 that is connected to the indoor unit controller 110 and provided for communicating with the terminal 200. In FIG. 1, the first communication module is shown as being included in the air conditioner. However, in other embodiments, the first communication module may be separate from and coupled to the air conditioner. For example, the first communication module may be a laptop or notebook computer, mobile terminal, or other device adapted for coupling to the controller of the air conditioner.

The air conditioner may be any one of a variety of types. For example, the air conditioner may be a split-type air conditioner, integrated air conditioner, wall- or window-mounted air conditioner, frame-type air conditioner, slim-type air conditioner, single-type air conditioner for driving one unit, medium-size air conditioner such as used in restaurants or companies, or a multi-air conditioner having a capacity sufficient to drive a plurality of indoor units.

By way of illustration, a split-type air may be one that includes a split indoor unit and outdoor unit, and integrated air conditioner may be one that includes an indoor unit and outdoor unit combined into one device.

In the illustrative case of when air conditioner 100 is a split-type air conditioner, the first communication module 120 may be described as being connected to the indoor unit controller 110. When the air conditioner 100 is an integrated air conditioner, the first communication module 120 may be understood as being connected to a controller of an air conditioner or a controller of an indoor unit. That is, the first communication module 120 may be described as being connected to one controller for controlling an operation of an air conditioner.

The indoor unit controller 110 and first communication module 120 may be connected by a serial communication system(a). As an example, the serial communication system may include a Universal Asynchronous Receiver/Transmitter (UART) system. The UART system may include an interface Integrated Chip (IC) (e.g., a line driver/receiver) that receives a transmitted signal, changes the received signal to a signal robust to noise, and extends a transmission distance of the signal. As the interface IC, there are RS232, RS422, and RS485. The serial communication system (a) may be called a first communication interface that is regulated inside the air conditioner 100, namely, between the indoor unit controller 110 and the first communication module 120 and interfaces information.

The terminal 200 may include a terminal controller 210 for controlling operation of the terminal and a second communication module 220 connected to the terminal controller and provided for wirelessly communicating with the air conditioner 100. The terminal controller 210 and second communication module 220 may be connected by a serial communication system (c). The serial communication system (c) may be the same serial communication system (a). The serial communication system (c) may be called a second communication interface that is regulated inside the terminal 200, namely, between the terminal controller 210 and the second communication module 220 and interfaces information.

The first and second communication modules 120 and 220 may be connected so as to enable wireless communication. The first and second communication modules 120 and 220 may be gateways that connect the air conditioner 100 and terminal 200. A communication system or link (b) between the first and second communication modules 120 and 220 may be a wireless communication system, and include Bluetooth, WiFi, Ad-hoc, or Zigbee. The communication system (b) may be called a third communication interface that is regulated between the air conditioner 100 and the terminal 200 and interfaces information.

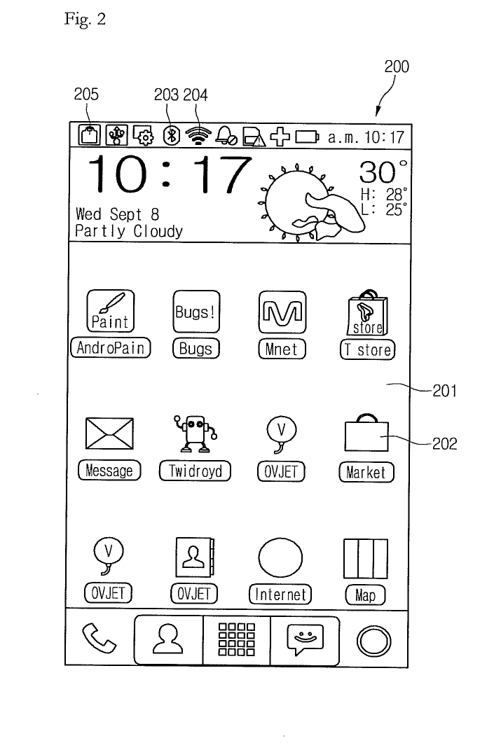

FIGS. 2-4 show examples of screens related to an operation for downloading an application to a terminal. According to one embodiment, terminal 200 may access the Internet or other network and download specific information from an external source. The terminal 200 may include a display unit 201 that displays specific content and may include at least one selection item or application for executing an operation of the terminal 200.

The selection item may include a web market selection unit 202 connected to a web server to enable downloading of specific info nation. When the web market selection item 202 is executed, the terminal 200 may be connected to the Internet for purposes of accessing a specific web server (e.g., a web market for downloading a specific program).

A user may input a specific command by touching the display unit 201. For example, a user may execute a plurality of selection items or applications including the web market selection item 202 with a touch pen, finger or the like.

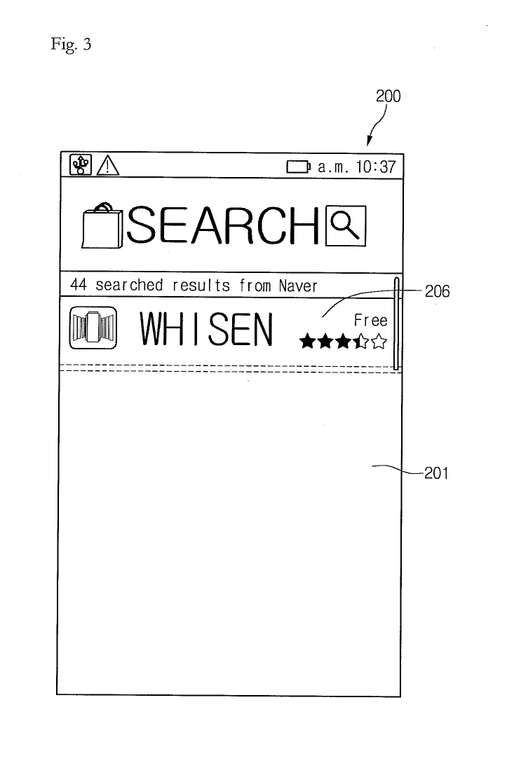

As shown in FIG. 3, the terminal 200 may execute the web market selection item 202 and then search a control program (e.g., an application) of the air conditioner 100. For example, when terminal 200 has searched to locate a control program named “WHISEN” to be downloaded, the searched result is displayed on a search result display unit 206 of the terminal 200.

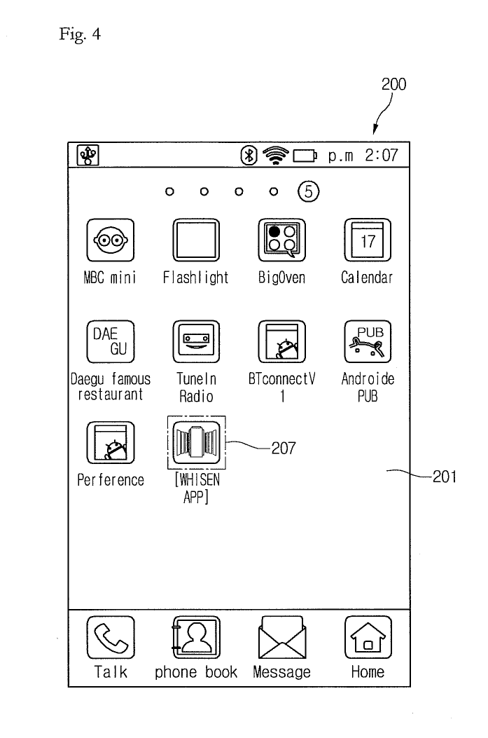

When the searched result is selected and executed, the display unit 201 may display content (for example, a pop-up window) associated with a procedure for downloading the control program, and the user may manipulate the terminal 200 according to the displayed content to download the control program. When downloading of the control program is completed as illustrated in FIG. 4, a display unit (i.e., an icon) indicating a control application 207 is generated and displayed on the display unit 201.

The display unit 201 may display, for example, a Bluetooth display item 203 and WiFi display unit 204 for displaying connection of a specific wireless communication system. The Bluetooth display unit 203 or WiFi display unit 204 may be activated according to the communication system connected to the terminal 200.

For example, when terminal 200 is Bluetooth-connected to another device, the Bluetooth display unit 203 may be activated, or when the terminal 200 is WiFi-connected to another device the WiFi display unit 204 may be activated. Alternatively, the Bluetooth display unit 203 and WiFi display unit 204 may be activated simultaneously. Moreover, the display unit 201 may include an update display notification unit 205 for displaying that there is specific information (e.g., a specific program) stored in the terminal 200 to be updated. In association with control application 207, when a function of an application is added or corrected, the update display notification unit 205 may be activated. Furthermore, the user may update the application with the web server (for example, web market).

As an example of an update method, when the web market execution unit 202 is selected, indication that “update is available” may be displayed for an application requiring update among applications stored in the terminal 200. The user may execute a corresponding application, and then add or correct a function of the application according to an update message.

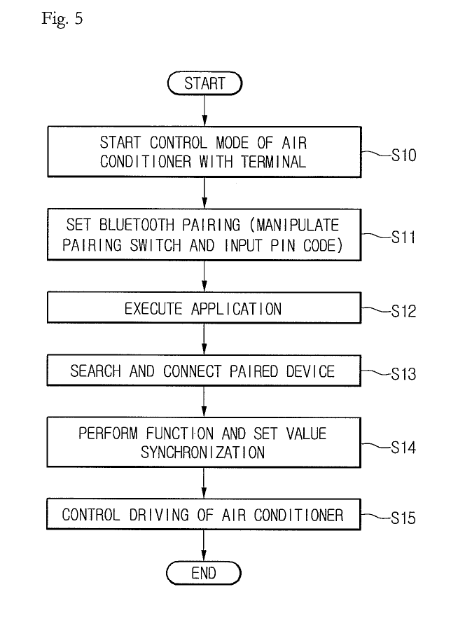

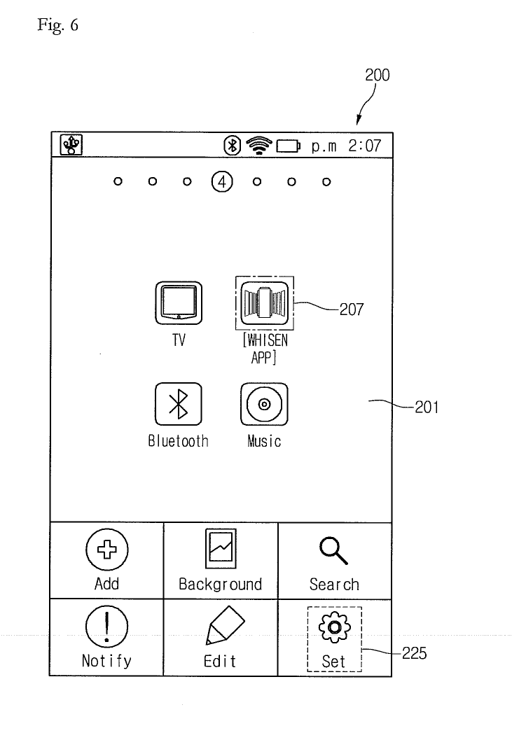

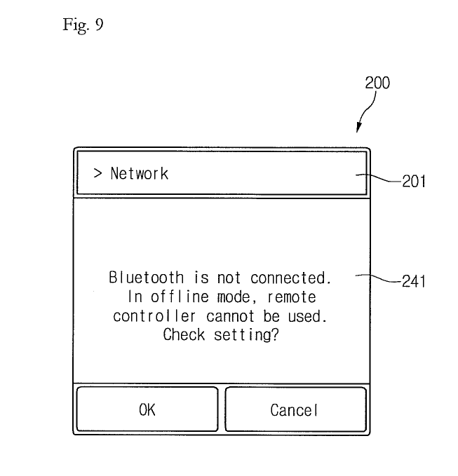

FIG. 5 shows one embodiment of a method for establishing communications between a terminal and an air conditioner, and FIGS. 6 to 8 show examples of content which may be displayed on a screen of the terminal when the terminal is in communication with an air conditioner. FIG. 9 shows an example of content displayed on the terminal screen when the terminal is not in communication with an air conditioner.

Referring to FIGS. 5 to 9, according to a first embodiment, terminal 200 may be connected to the air conditioner 100 for purposes of controlling the driving of the air conditioner. In this embodiment, terminal 200 may be connected to the air conditioner 200 by a Bluetooth system. In other embodiments, another communication link or protocol may be used to establish the connection. Examples include any one of a number of short-range, local or long-distance links or protocols.

As previously indicated, when a control application has been downloaded to terminal 200, a control mode of the air conditioner 100 may be started by the terminal 200 in operation S10. More specifically, as an initial operation, a pairing operation is set and performed for establishing a Bluetooth connection between terminal 200 and air conditioner 100. The pairing operation is performed to form a connection between two Bluetooth devices and is based on the exchange of one or more pin codes between the devices, for security. The pairing may be executed only once in an initial stage for Bluetooth connection. Pairing-related information may be stored in a Bluetooth device list of the terminal 200, so that, for example, communications may be automatically connected at a subsequent time.

The communication module 120 includes a pairing switch. For Bluetooth pairing, a device searchable mode is entered by manipulating the pairing switch for a certain time. If the pairing switch is not pushed, device search for Bluetooth connection may not be performed. The user inputs the pin code with the terminal 200 and thus pairing is completed. However, if the pairing fails, the air conditioner 100 or terminal 200 may display a pairing failure message in operation S11.

The pairing may be performed between the air conditioner 100 and terminal 200, and thereafter the terminal 200 may execute a control program (i.e., an application) in operation S12. If the control program is executed, by searching a paired device, Bluetooth automatic connection with an air conditioner to be controlled is attempted. When the number of air conditioners to be controlled is two or more, connection may be attempted in order.

In an operation where establishing a Bluetooth connection is attempted between two devices (for example, a terminal and an air conditioner), the display unit 201 of the terminal 200 may display a message indicative of “being connected to an air conditioner”. Furthermore, when the Bluetooth connection is completed, the display unit 201 may display a message indicative of “connected to an indoor unit” in operation S13.

In operation S14, when a Bluetooth connection is established between the terminal 200 and air conditioner 100, the terminal 200 may perform a synchronizing operation which uses the function of the air conditioner 100 or a state value that is set in the air conditioner 100. Herein, the synchronizing operation may include a function synchronizing operation or a set value synchronizing operation. When synchronization for the function or set value of the air conditioner 100 is performed in the terminal 200, the terminal 200 may control the driving of the air conditioner 100 in operation S15.

FIGS. 6 to 9 show examples of content that may be displayed by the terminal 200 when Bluetooth pairing has been set between the terminal 200 and air conditioner 100, and Bluetooth connection has either succeeded or failed.

As shown in FIG. 6, the display unit 201 of the terminal 200 may display the control application 207 that has been downloaded from a web market (e.g., App Store). Furthermore, the display unit 201 may include a setting tab 225 for setting the communication system of the terminal 200.

As described above, for Bluetooth pairing, the user first pushes the pairing switch of the communication module 120. Subsequently, the setting tab 225 of the terminal 200 may be executed. When the setting tab 225 is executed, the display unit 201 may sequentially display a wireless and network selecting operation, a Bluetooth setting operation, a Bluetooth device searching and selecting operation, in which case the user may execute the operations with an input command.

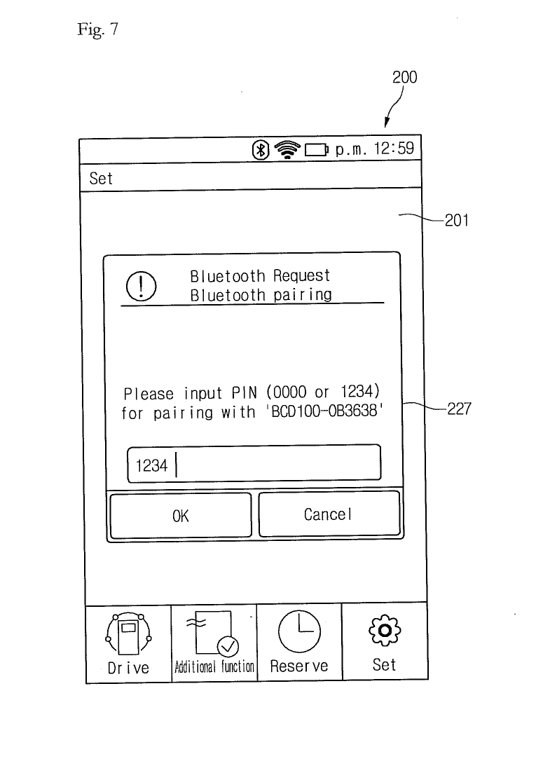

When a Bluetooth device to be paired has been selected, as illustrated in FIG. 7, the display unit 201 may display a message “requiring Bluetooth pairing” and the user may input the pin code and then push an OK button. When the pin code is normally inputted, the display unit 201 may display a message indicative of “paired but not connected.”

As described above, the paring is completed and then when a control program (i.e., an application) is executed, Bluetooth automatic connection is started between the air conditioner 100 and terminal 220. When the automatic connection is completed, it can be understood that control connection for transmitting a message packet is formed between the air conditioner 100 and terminal 200.

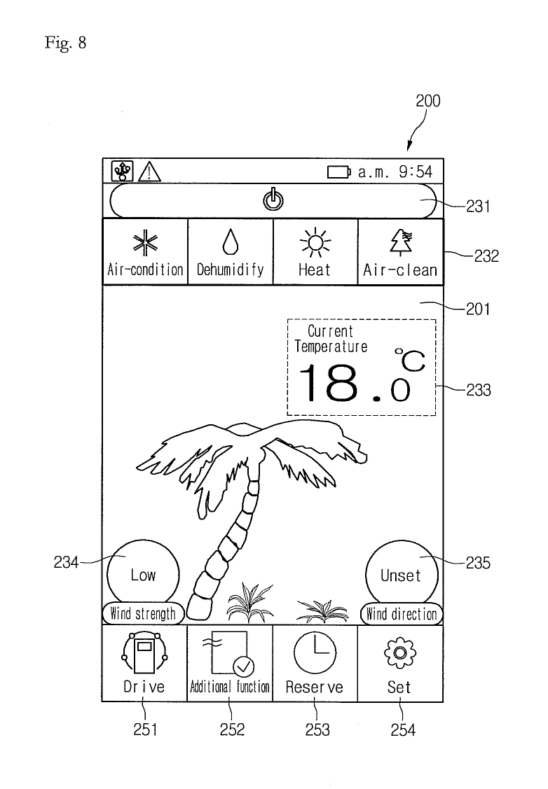

When the control connection has been formed, as illustrated in FIG. 8, the display unit 201 displays various display units (or selection units) indicating the functions of the air conditioner 100.

More specifically, the display unit 201 may include a power source display unit 231 that displays the power-on/off of the air conditioner 100, a driving mode display unit 232 that displays whether to perform the air-conditioning, dehumidifying, heating, or air-cleaning driving of the air conditioner 100, a temperature display unit 233 that displays temperature information, a wind strength display unit 234 that displays the strength of the wind discharged from the air conditioner 100, and a wind direction display unit 235 that displays the direction of the wind.

The display unit 201 may also include a driving tab 251 for controlling various functions of the air conditioner 100, an additional function tab 252, a reservation tab 253, and a setting tab 254.

FIG. 9 shows an example of information that may be displayed on the display unit 201 when Bluetooth pairing is not set, or when Bluetooth automatic connection has failed after pairing. As shown, the display unit 201 may display a connection failure display message 241 indicating that Bluetooth connection failed. The message may be displayed when and/or provide info illation indicating that the Bluetooth connection has failed, connection between the first and second communication modules 120 and 220 is unable to be established, and/or a wrong pin code has been input.

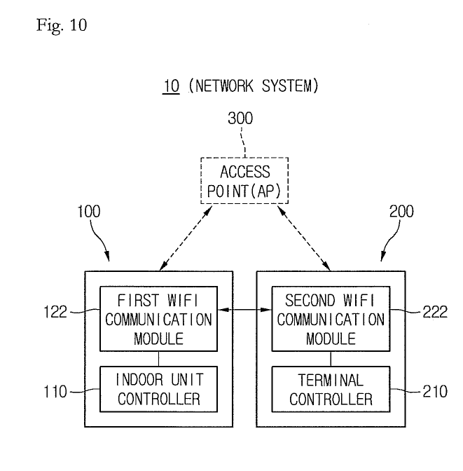

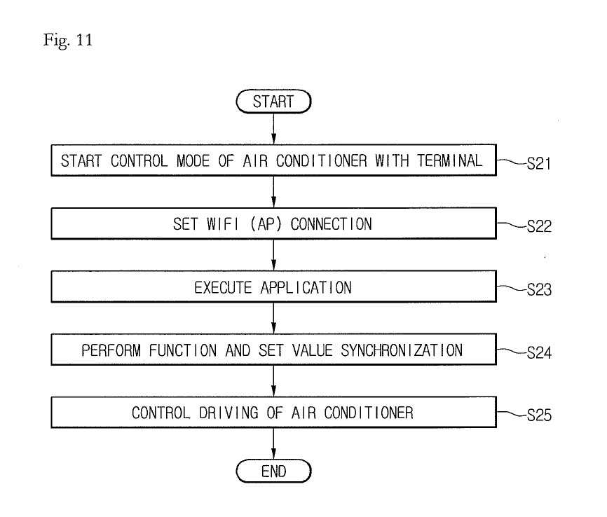

FIG. 10 shows an embodiment of one possible communication configuration for a terminal and air conditioner, and FIG. 11 shows an embodiment of a method for establishing communications between a terminal and air conditioner.

As shown in FIG. 10, a network system 10 may include an air conditioner 100, a terminal 200, and an access point (AP) 300 that connects the air conditioner 100 and terminal 200 to enable communication therebetween. The air conditioner 100 and terminal 200 may be connected by the WiFi system so as to enable communication therebetween.

The air conditioner 100 may include an indoor unit controller 110 for controlling an operation of the air conditioner 100, and a first WiFi communication module 122 that is connected to the indoor unit controller 110 and communicates with the terminal 200. Furthermore, the terminal 200 may includes a terminal controller 210 for controlling an operation of the terminal 200, and a second WiFi communication module 222 connected to the terminal controller 210 and communicates with first WiFi communication module 122.

A communication-enabled environment is set between the first and second WiFi communication modules 122 and 222 through the access point 300. The access point 300 may be understood as a device that provides a wireless Local Area Network (LAN) environment in connection with the Internet line.

Referring to FIG. 11, when terminal 200 starts a control mode for controlling air conditioner 100 in operation S21, access point connection is set by the WiFi communication system.

In setting this connection, a security function may be performed such as encryption/authentication for the access point 300. For example, a user may set or enter a password of the access point 300. When the user desires to control the air conditioner 100 with terminal 200, the user sets a wireless Internet use environment by inputting the password of the access point 300, and thereafter searches the air conditioner 100 from the access point 300 to connect communication between the air conditioner 100 and terminal 200 in operation S22.

When the wireless Internet use environment is not set or communication is not established between air conditioner 100 and terminal 200, terminal 200 or air conditioner 100 may display the indication of a communication error.

The air conditioner 100 and terminal 200 may be connected by the WiFi communication system, and then a control program (for example, an application) may be executed in operation S23. Synchronization for the function and set value of the air conditioner 100 may be performed in operation S24. When the function and set value of the air conditioner 100 have been synchronized with the terminal 200, the terminal 200 may control the driving of the air conditioner 100 in operation S25.

In the above-described embodiment, the air conditioner 100 and terminal 200 have been described as being connected by the access point 300 so as to enable communication therebetween. In another embodiment, the air conditioner 100 and terminal 200 may be directly connected so as to enable communication therebetween, according to a WiFi direct technology or an Ad-hoc technology. In this case, the access point 300 may not be provided, one of the air conditioner 100 and terminal 200 may transmit/receive data to/from the other.

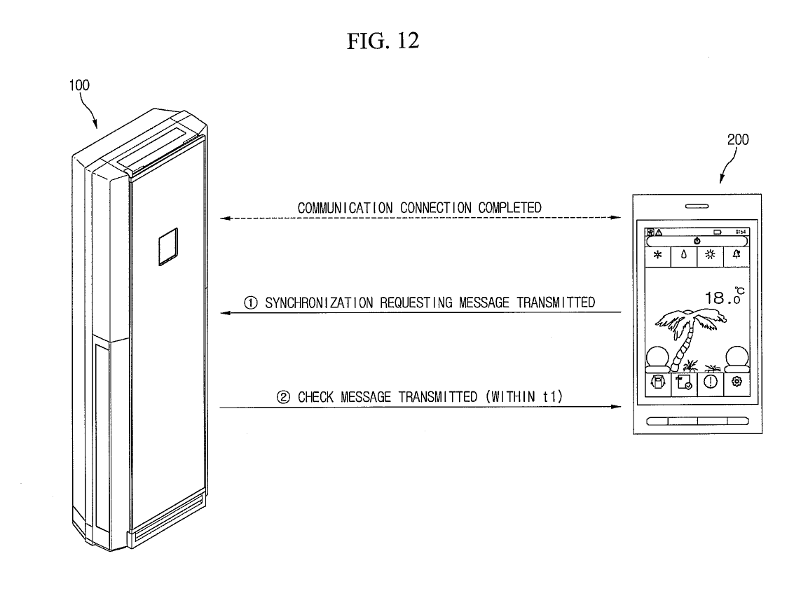

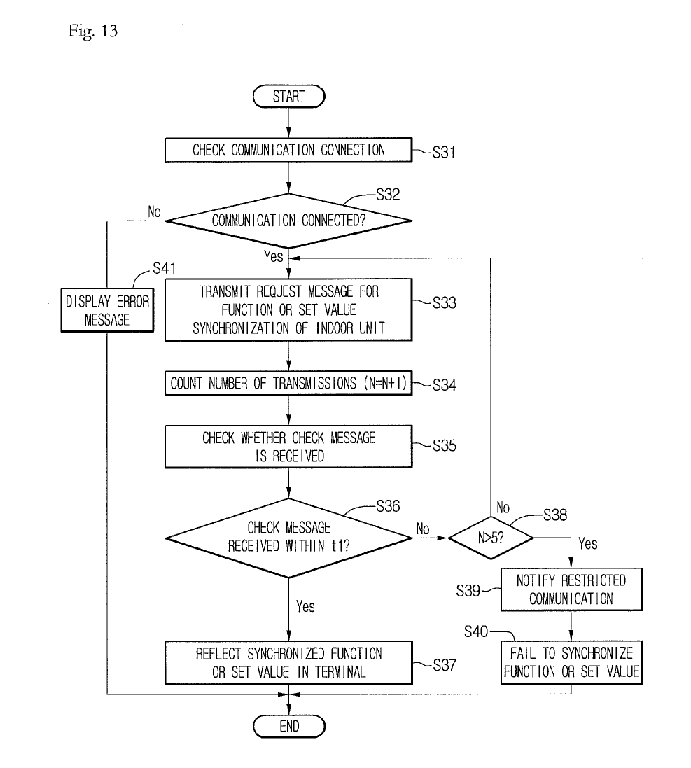

FIG. 12 shows an embodiment which includes an operation for performing synchronization between a terminal and air conditioner, and FIG. 13 shows an embodiment of a method for performing synchronization between a terminal and air conditioner. Referring to FIGS. 12 and 13, when a communication connection is completed between the air conditioner 100 and terminal 200, a synchronizing operation for fetching information of the air conditioner 100 is performed in the terminal 200.

The synchronizing operation may include a function synchronizing operation that fetches various functions of the air conditioner 100, and a set value synchronizing operation that fetches the set state value of the air conditioner 100. In the function synchronizing operation and the set value synchronizing operation, synchronized targets may be different. In another embodiment, the targets for and/or the function synchronizing operation may be similar to the set value synchronizing operation.

A function synchronization list may include a driving mode, wind strength, temperature range, temperature control method, product group, wind direction, additional function, reservation function, reservation set time and range of the air conditioner 100. A set value synchronization list may include a plurality of set state values associated with a driving mode, set temperature, wind strength, set air volume, wind direction, additional function and reservation function reservation set time and range of the air conditioner 100.

A synchronizing operation will now be described. First, a synchronization requesting message is transmitted from the terminal 200 to the air conditioner 100. When the terminal 200 receives a check message from the air conditioner 100 within a predetermined time “t1” (for example, 100 ms), synchronization may be performed.

Although the synchronization requesting message has been transmitted, when the check message is not received within the time “t1,” an operation of retransmitting the synchronization requesting message is performed by the number of predetermined times. Even in the retransmitting operation, when the check message is not received from the air conditioner 100, the display unit 201 may display a synchronization error message. In this way, the function synchronization or set value synchronization of the air conditioner 100 may be performed.

In the above description, the terminal 200 has been described as transmitting the synchronization requesting message, and the air conditioner 100 has been described as transmitting the check message. In another embodiment, the air conditioner 100 may transmit the synchronization requesting message and the terminal 100 may transmit the check message.

The set value synchronization of the air conditioner 100 will now be described below in more detail. When a set value of the air conditioner 100 is changed, set value synchronization of the air conditioner 100 may be performed. That is, when the set value of the air conditioner 100 is changed, the air conditioner 100 may transmit the changed content to the terminal 200 automatically and the terminal 200 may receive a check signal for the air conditioner 100. At this point, the terminal 200 may display the changed content.

The set value synchronization of the air conditioner 100 may be performed when execution of an application is on or off after the function synchronizing operation is completed, the application has been closed on the terminal, the display unit 201 of the terminal 200 is changed from an off state to an on state, the application is changed from an inactive state to an active state, or the set value of the air conditioner 100 is changed.

A case where the application is changed from the inactive state to the active state may, for example, include: a case where the terminal 200 stops the execution of an application in the middle of executing the application, executes another program, and then again returns to the application; or a case where an interrupt such as call or text message occurs while the application is being executed and then the terminal 200 again returns to the application. Even when robot cleaning or automatic drying is performed or performing reservation is completed in the functions of the air conditioner 100, the set value synchronization of the air conditioner 100 may be performed.

An embodiment of a control method of a network system for synchronization will be described below with reference to FIG. 13. First, whether communication is connected between the air conditioner 100 and terminal 200 is checked in operation S31. When the air conditioner 100 and terminal 200 are completed in operation S32, one of the air conditioner 100 and terminal 200 transmits a request message for function or set value synchronization, to the other in operation S33. When one of the air conditioner 100 and terminal 200 receives the request message, the number of transmissions is counted (e.g., N=N+1) in operation S34.

Whether one of the air conditioner 100 and terminal 200 receives a check message from the other is checked in operation S35. When the check message is received within a predetermined time “t1,” the synchronized function or set value of the air conditioner 100 is reflected in the terminal 200 in operations S36 and S37.

On the other hand, when the check message is not received within the predetermined time “t1”, whether the number of transmissions “N” is greater than 5 is determined. Herein, a value of 5 may be understood as an arbitrary or predetermined value corresponding to the repetitive transmission of the request message, but may be set as another value, in operation S38. When the N value is not greater than 5, the control method returns to operation S33.

However, when the N value is recognized as greater than 5, a state where connection is restricted between the air conditioner 100 and terminal 200 is notified to the outside by the air conditioner 100 or terminal 200 (e.g., screen display or sound), the function or set value synchronization of air conditioner 100 fails in operations S39 and S40.

When communication connection is recognized as not being formed in operation S32, the terminal 200 or air conditioner 100 may display an error message in operation S41.

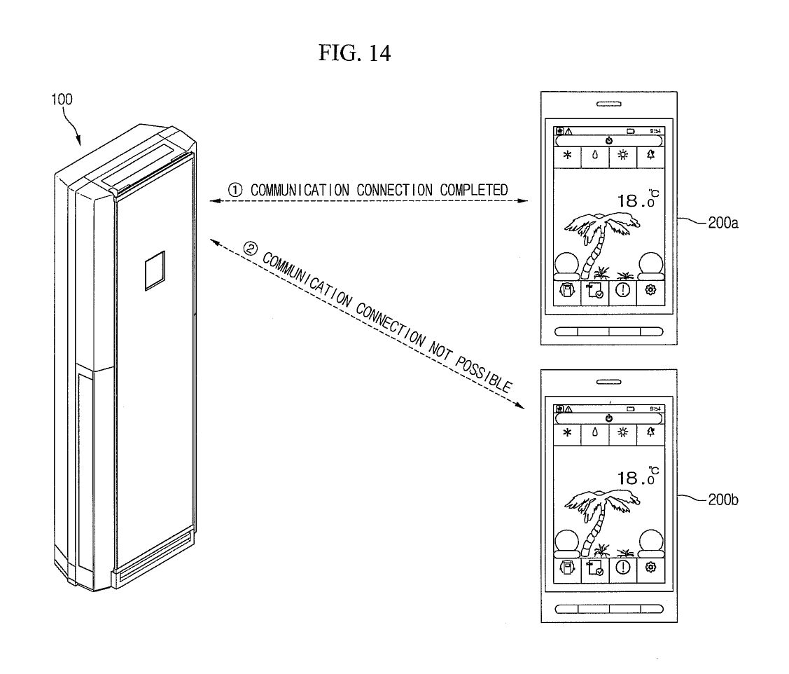

FIG. 14 shows an embodiment which includes an operation where a plurality of terminals attempt to connect communication with an air conditioner. Referring to FIG. 14, an air conditioner 100 may be connected to one of a plurality of terminals so as to enable communication. The plurality of terminals in this example include first and second terminals 200a and 200b.

When communication is established between the first terminal 200a and the air conditioner 100, communication connection of the second terminal 200b is restricted for preventing function (control) confusion between a plurality of users that respectively carry the terminals 200a and 200b.

While the first terminal 200a is being communication-connected to the air conditioner 100, when the first terminal 200a enters a standby mode, the second terminal 200b may be communication-connected to the air conditioner 100. Herein, the standby mode denotes that a process of the terminal 200 is not ended but in a stationary state.

A case where the terminal 200 is in the standby mode may, for example, include: a case where a light emitting state of the display unit 201 is an off state; a case where an application is executed while another application is being executed; or a case where a command for changing an initial screen of the terminal 200 is inputted while an application is being executed. Through such operations, a plurality of terminals may control the driving of an air conditioner, but only one terminal may be communication-connected to and/or the air conditioner at any given time, thus preventing confusion between control functions from multiple terminals.

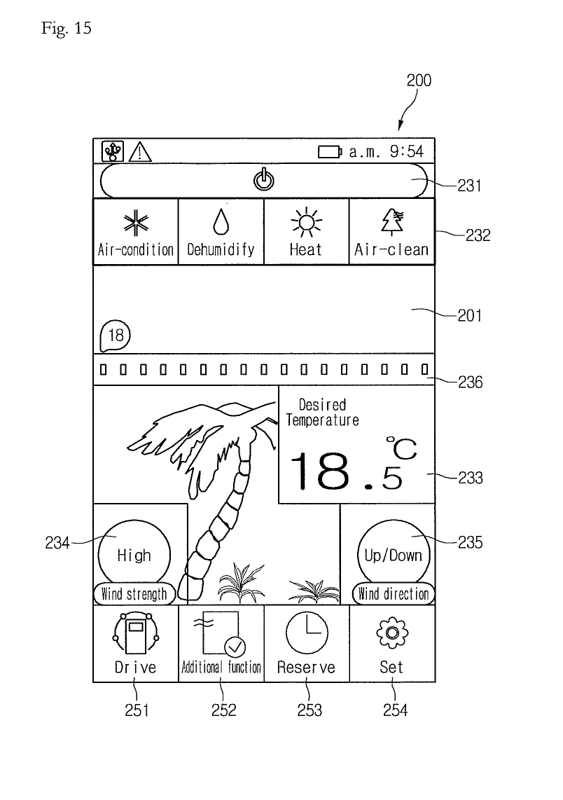

FIGS. 15 to 18 show an embodiment which includes an operation where a terminal displays various functions of an air conditioner. Referring to FIG. 15, the terminal 200 includes a driving tab 251 that enables the execution of a function associated with the driving of the air conditioner 100. When the driving tab 251 is executed while a control program (i.e., an application) of the air conditioner 100 is being executed, a menu related to the driving of the air conditioner 100 may be displayed. Functions associated with the driving tab 251 are relevant to an item that is frequently used by a user, and thus the driving tab 251 is provided as a display unit that is immediately executable on an execution initial screen of the application.

More specifically, the display unit 201 includes a power source display unit 231 that displays the power-on/off of the air conditioner 100, a driving mode display unit 232 that displays whether to perform the air-conditioning, dehumidifying, heating, or air-cleaning driving of the air conditioner 100, a temperature display unit 233 that displays temperature information, a temperature control unit 236 for setting a desired temperature to be controlled, a wind strength display unit 234 that displays the strength of the wind discharged from the air conditioner 100, and a wind direction display unit 235 that displays the direction of the wind. The driving of the air conditioner 100 may be controlled by touching the display units or control unit.

The power source display unit 231 displays whether the air conditioner 100 (particularly, the indoor unit thereof) is driven. The driving mode display unit 232 displays a currently set driving mode. However, a user may change a set driving mode to another driving mode by touching the other driving mode.

The temperature display unit 233 may display a current indoor temperature, and the user may set a desired temperature by manipulating the temperature control unit 236 with a scroll. When the desired temperature has been set, the temperature display unit 233 may display the desired temperature for a predetermined amount of time (e.g., about 2 sec to about 3 sec) and then again display a current temperature. Content displayed (set) on the wind strength display unit 234 or wind direction display unit 235 may be changed by pushing the wind strength display unit 234 or wind direction display unit 235 in a left or right direction.

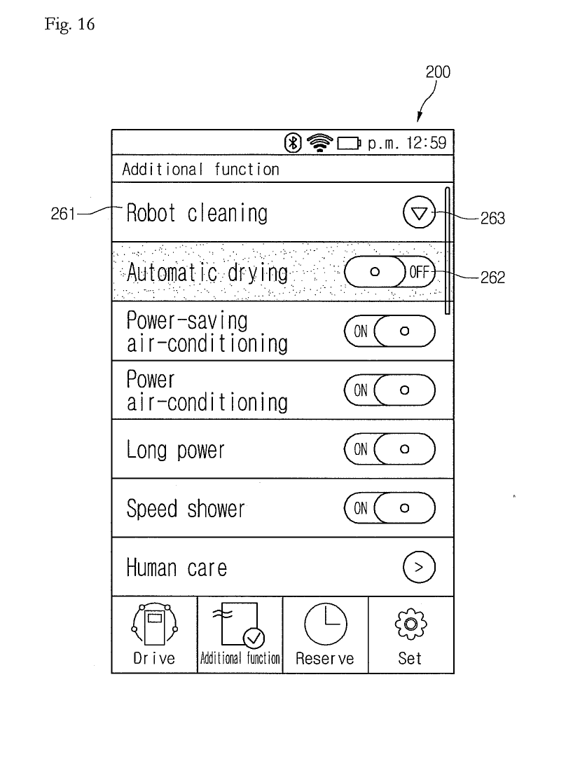

FIG. 16 shows information that may be displayed on the display unit 201 when an additional function tab 252 is selected. An additional function of the air conditioner 100 may include “robot cleaning,” “automatic drying,” “power-saving air-conditioning,” “power air-conditioning,” “long power,” “speed shower,” “human care,” “forest wind,” “brightness control,” and “mood lighting.”

The robot cleaning function may be understood to be a function executed for automatically cleaning a filter member included in the air conditioner 100.

The automatic drying function may be a function that automatically dries inside the indoor unit when driving is stopped in an air-conditioning or dehumidifying driving operation.

The power-saving air-conditioning function may include a function executed in an air-conditioning mode for saving electricity cost or power consumption.

The power air-conditioning function may be a function executed for strong air-conditioning driving.

The long power function may be a function that transfers wind to a relatively long location by setting the strength of the wind as the power wind (e.g., strong wind).

The speed shower function may be a function that controls wind discharged from the indoor unit in a predetermined specific scheme.

The human care function may be a function that controls discharged wind when the wind is directly discharged to the user (for example, direct wind) or the wind is indirectly discharged to the user (for example, indirect wind).

The forest wind function may be a function to set the strength of a wind as a natural wind (i.e., a general wind power), provide natural scent, and make an indoor space pleasant.

The brightness control function may be a function to control a light emitting state or degree in order for the display unit 201 to be shown to the outside.

The mood lighting function may be a function to execute an indirect lighting means of the terminal 200. As described above, various functions of the air conditioner 100 including the ones described above (as well as others depending on the type of air conditioner) can be realized by manipulating additional function tab 252.

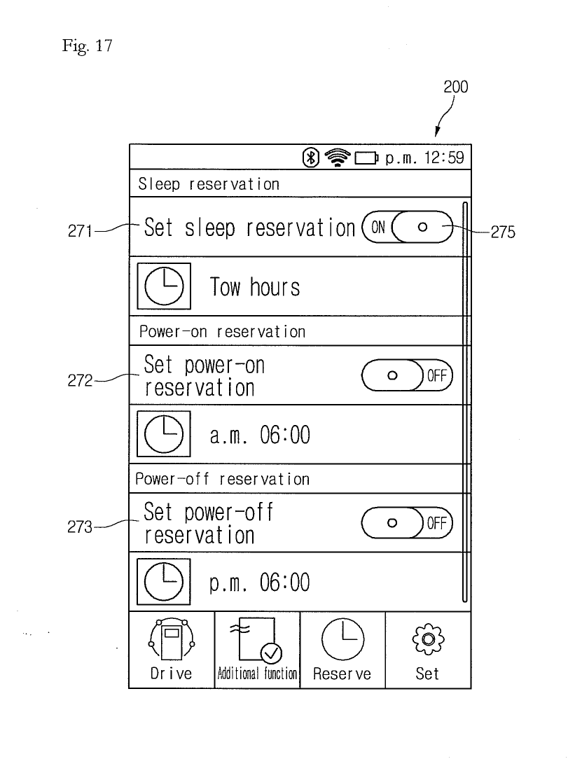

FIG. 17 shows an example of a screen associated with a reservation function for reserving the driving time of the air conditioner 100. When a reservation tab 253 is executed, the display unit 201 displays a sleep reservation setting unit 271, a power-on reservation setting unit 272, and a power-off reservation setting unit 273. An on/off selection unit 275 for controlling the on/off of the setting units 271, 272 and 273 is disposed at one side of the setting units 271, 272 and 273.

A sleep reservation function is a function that is set in sleeping, and may be set while the air conditioner 100 is being driven. A specific time may be set by the sleep reservation setting unit 271. When an on function is selected by the on/off selection unit 275, the driving of air conditioner 100 may be controlled to be turned off after the set time.

The power-on reservation function is a function that allows the air conditioner 100 to be automatically turned on at a reserved time, and may be set when the air conditioner 100 is in an on state or an off state. The air conditioner 100 may be on at a reserved power-on time. On the other hand, the power-off reservation function is a function that allows the air conditioner 100 to be automatically turned off at a reserved time, and may be set when the air conditioner 100 is in an on state or an off state. The air conditioner 100 may be off at a reserved power-off time.

In this way, a user may selectively drive the air conditioner 100 at a necessary time with the reservation tab 253, and thus can save electricity cost and increase the convenience of use.

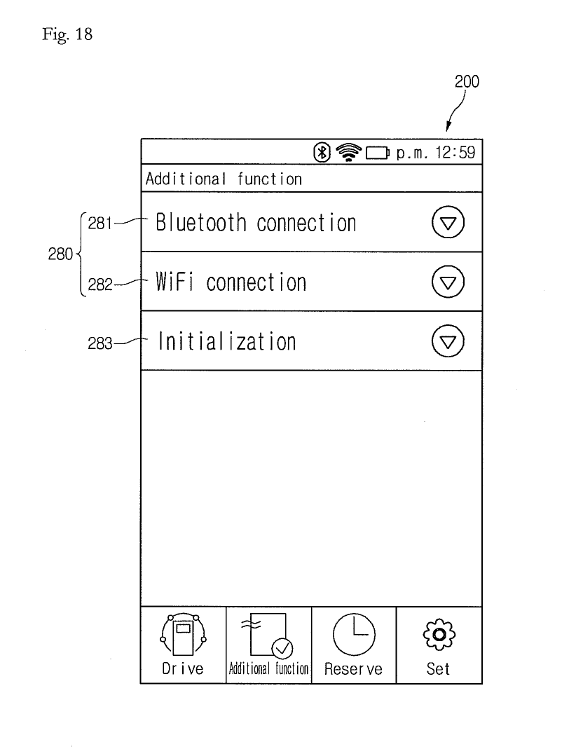

FIG. 18 shows an example of a set function screen associated with the communication connection of the air conditioner 100. When a setting tab 254 is executed, a communication system setting unit 280 and an initialization selection unit 283 are displayed on the display unit 201. The communication system setting unit 280 may include a Bluetooth connection unit 281 and/or a WiFi connection unit 282. The communication connection system of the terminal 200 may be set by manipulating the Bluetooth connection unit 281 or WiFi connection unit 282. For example, when intending to Bluetooth-connect the air conditioner 100 and terminal 200, the Bluetooth connection unit 281 is executed, or when intending to WiFi-connect the air conditioner 100 and terminal 200 the WiFi connection unit 282 is executed.

When executing the initialization selection unit 283, the communication system of the terminal 200 may be reset to an initial state. In this way, a user can easily set or change the communication systems of the air conditioner 100 and terminal 200, with the setting tab 254.

According to one or more of the embodiments described herein, a terminal can remotely control operation of an appliance or system. In one embodiment, the appliance is an air conditioner. In other embodiments, other types of appliances and/or systems may be controlled including ones in a home, industrial, commercial or office setting.

The terminal may download specific information from the web server and controls the operation of the air conditioner on the basis of the downloaded information, thus enhancing accessibility to the air conditioner. Moreover, because the downloaded information includes various functions for controlling the air conditioner, the terminal can easily set or change the function of the air conditioner. Moreover, the encryption or authentication function may be set in an operation where the terminal and the air conditioner are connected so as to enable communication therebetween, communication-related security can be strengthened.

Moreover, when a plurality of terminals try to connect with the air conditioner, only one terminal is allowed to be connected to and control the air conditioner, thus preventing the functions of the air conditioner from being confused by a plurality of users. According to one or more embodiments, an air conditioner and a terminal are connected so as to enable wireless communication, and an operation of the air conditioner is remotely controlled or monitored by the terminal, thus enhancing availability of industry.

One or more embodiments also provide a network system which controls operation of an appliance with a terminal which downloads predetermined information from a web server. In accordance with one embodiment, the terms appliance and system may be synonymous or used interchangeably to refer to any device or system to be controlled, as previously described.

In accordance with one embodiment, a control method of a network system includes: downloading an application to a terminal, for controlling an air conditioner; connecting the terminal and air conditioner to enable communication therebetween; synchronizing a function or set value of the air conditioner with the terminal, when the terminal and air conditioner are communication-connected; and controlling an operation of the air conditioner with the terminal.

In another embodiment, a network system includes: an air conditioner discharging conditioned air to a space, the air conditioner being installed in the space; a first communication interface regulated in the air conditioner, and interfacing information or control information on an operation of the air conditioner; a terminal controlling the operation of the air conditioner, and downloading an application from a web server; a second communication interface regulated in the terminal, and interfacing the information or control info illation on the operation of the air conditioner; and a third communication interface regulated between the terminal and air conditioner, and interfacing the information or control information on the operation of the air conditioner.

In another embodiment, a network system includes: an air conditioner discharging conditioned air to a space, the air conditioner being installed in the space; a terminal controlling an operation of the air conditioner, and downloading an application from a web server; and a gateway included in each of the air conditioner and terminal, and enabling mutual communication between the air conditioner and terminal, wherein, synchronization for reflecting a function or set value of the air conditioner in the terminal is performed when the application is executed, and while the synchronization is being performed, one of the air conditioner and terminal transmits a synchronization requesting message, and the other transmits a check message.

In another embodiment, a wireless control method comprises receiving an application into a terminal for controlling an appliance; establishing a wireless link between the terminal and appliance; synchronizing an attribute of the appliance with the terminal through the wireless link, the attribute corresponding to a function or set value of the appliance; displaying information identifying the function or set value on the terminal; receiving a first signal corresponding to an operation to be performed for the appliance, the first signal generated based on selection of an item displayed on the terminal or based on information entered into the terminal; and transmitting a second signal to control performance of the appliance operation. The appliance may be an air conditioner or another appliance or system.

The application may be received through a first interface, and the wireless link may be established through a second interface. The first interface may be coupled to the Internet and the second interface may be coupled to a short-range communication link. The terminal may be one which performs at least one of a voice call, video call, or transmits or receives data to or from another terminal, or another type of terminal may be used. Examples of terminals include mobile phones, PDAs, notebook, laptop or handheld computers, and well as other devices which may or may not be mobilie.

The wireless link may be established by pairing the terminal and appliance through a short-range link. The pairing may be performed based on a code transmitted between the terminal and appliance, and the short-range link may be a Bluetooth link or another type of link. Info illation may be displayed on the terminal indicating success or failure of the pairing.

The method may further include executing the application after paring, and transmitting a message between the appliance and terminal after execution of the application.

Also the wireless link may be a WiFi-link established through or with an access point, or the wireless link may be a direct WiFi link or an Ad-hoc link established without an access point.

Synchronizing may be performed based on changing a driving state of the application to an on state or an off state, changing an inactive state of the application to an active state, deactivating a display of the terminal, or changing the set value of the air conditioner. Additionally, or alternatively, synchronizing may be performed based on execution of a robot cleaning function of the air conditioner, an automatic drying function of the air conditioner, or execution of a reservation operation.

In accordance with another embodiment, a terminal comprises a first interface to receive an application for controlling an appliance, a memory to store the application received through the first interface, and a controller to control formation of a wireless link between the terminal and appliance, synchronization of an attribute of the appliance through the wireless link, and display of information identifying a function or set value corresponding to the attribute, wherein the controller controls execution of the application to transmit a first signal and wherein the first signal to cause an operation to be performed for the appliance. The first signal may be generated based on selection of an item displayed on a screen or based on information entered into the terminal.

Also, the terminal may include a second interface to transmit the first signal, wherein the first interface is coupled to a network server and the second interface is coupled to short-range link. The first interface may be coupled to the server through the Internet and the short-range link may be a WiFi link or a Bluetooth link. The appliance may be an air conditioner, and the terminal may be a mobile terminal.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. The features of any one embodiment may be combined with one or more features of the remaining embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A wireless control method comprising:
receiving an application into a terminal for controlling an appliance;
establishing a wireless link between the terminal and appliance;
synchronizing an attribute of the appliance with the terminal through the wireless link, the attribute corresponding to a function or set value of the appliance;
displaying information identifying the function or set value on the terminal;
receiving a first signal corresponding to an operation to be performed for the appliance, the first signal generated based on selection of an item displayed on the terminal or based on info nation entered into the terminal; and
transmitting a second signal to control performance of the appliance operation.

2. The method of claim 1, wherein the appliance is an air conditioner.

3. The method of claim 1, wherein:
the application is received through a first interface, and
the wireless link is established through a second interface.

4. The method of claim 3, wherein the first interface is coupled to the Internet and the second interface is coupled to a short-range communication link.

5. The method of claim 1, wherein the terminal performs at least one of a voice call, video call, or transmits or receives data to or from another terminal.

6. The method to claim 1, wherein establishing the wireless link includes pairing the terminal and appliance through a short-range link.

7. The method of claim 6, wherein the short-range link is a Bluetooth link.

8. The method of claim 6, wherein said pairing is performed based on a code transmitted between the terminal and appliance.

9. The method of claim 6, further comprising:
displaying information on the terminal indicating failure of said pairing.

10. The method of claim 6, further comprising:
executing the application after said paring, and
transmitting a message between the appliance and terminal after execution of the application.

11. The method of claim 1, wherein the wireless link is a WiFi-link established through or with an access point.

12. The method of claim 1, wherein the wireless link is a direct WiFi link or an Ad-hoc link established without an access point.

13. The method of claim 1, wherein said synchronizing is performed based on:
changing a driving state of the application to an on state or an off state,
changing an inactive state of the application to an active state,
deactivating a display of the terminal; or
changing the set value of the air conditioner.

14. The method of claim 2, wherein said synchronizing is performed based on:
execution of a robot cleaning function of the air conditioner,
an automatic drying function of the air conditioner, or
execution of a reservation operation.

15. A terminal comprising:
a first interface to receive an application for controlling an appliance;
a memory to store the application received through the first interface; and
a controller to control formation of a wireless link between the terminal and appliance, synchronization of an attribute of the appliance through the wireless link, and display of information identifying a function or set value corresponding to the attribute, wherein the controller controls execution of the application to transmit a first signal and wherein the first signal to cause an operation to be performed for the appliance.

16. The terminal of claim 15, wherein the first signal is generated based on selection of an item displayed on a screen or based on information entered into the terminal.

17. The terminal of claim 15, further comprising:
a second interface to transmit the first signal,
wherein the first interface is coupled to a network server and the second interface is coupled to short-range link.

18. The terminal of claim 17, wherein the first interface is coupled to the server through the Internet and wherein the short-range link is a WiFi link or a Bluetooth link.

19. The terminal of claim 15, wherein the appliance is an air conditioner.

20. The terminal of claim 15, wherein the terminal is a mobile terminal.
